(19) United States
(12) Patent Application Publication
(10) Pub. No.: US 2025/0045762 A1
(43) Pub. Date: Feb. 6, 2025

(54) System, Method, and Computer Program Product for Graph-Based Fraud Detection

(71) Applicant: Visa International Service Association, San Francisco, CA (US)

(72) Inventors: Anurag Tangri, Burlingame, CA (US); Chiranjeet Chetia, Round Rock, TX (US)

(21) Appl. No.: 18/715,248

(22) PCT Filed: Dec. 2, 2022
(86) PCT No.: PCT/US22/51607

§ 371 Date: May 31, 2024

Related U.S. Application Data
(60) Provisional application No. 63/285,225, filed on Dec. 2, 2021.

(51) Int. Cl. G06Q 20/40

(52) U.S. Cl. CPC G06Q 20/4016

(57) ABSTRACT

A method, system, and computer program product is provided for graph-based fraud detection. The system includes at least one processor programmed or configured to generate a graph data structure based on a plurality of transactions between a plurality of accounts, wherein each account of the plurality of accounts is represented by a node in the graph data structure, and wherein each transaction of the plurality of transactions is represented by an edge in the graph data structure, determine a plurality of features of the graph data structure for each account of the plurality of accounts, generate a graph profile for at least one account of the plurality of accounts based on the plurality of features for the at least one account, and update the graph profile for the at least one account based on at least one new transaction engaged in by the at least one account.

### CROSS REFERENCE TO RELATED APPLICATIONS

This application is the United States national phase of International Application No. PCT/US2022/051607 filed Dec. 2, 2022, and claims priority to U.S. Provisional Patent Application No. 63/285,225, filed Dec. 2, 2021, the disclosures of which are hereby incorporated by reference in their entireties.

### BACKGROUND

### 1. Technical Field

This disclosure relates generally to fraud detection and, in non-limiting embodiments or aspects, to systems, methods, and computer program products for graph-based fraud detection.

### 2. Technical Considerations

Existing fraud detection systems may fail to detect certain fraudulent activity in newer payment methods, such as real-time payments. For example, payment networks pose the risk of fraud being conducted by individuals and/or groups of individuals. Existing fraud detection systems consider individual accounts and can result in missing fraudulent activity and/or mislabeling legitimate activity as fraudulent.

### SUMMARY

Accordingly, provided are improved systems, methods, and computer program products for graph-based fraud detection.

According to non-limiting embodiments or aspects, provided is a computer-implemented method, comprising: generating, with at least one processor, a graph data structure based on a plurality of transactions between a plurality of accounts, wherein each account of the plurality of accounts is represented by a node in the graph data structure, and wherein each transaction of the plurality of transactions is represented by an edge in the graph data structure; determining, with the at least one processor, a plurality of features of the graph data structure; generating, with the at least one processor, a graph profile for at least one account of the plurality of accounts based on the plurality of features for the at least one account, the graph profile based on account activity over each of a plurality of time periods; and updating, with the at least one processor, the graph profile for the at least one account based on at least one new transaction engaged in by the at least one account.

In non-limiting embodiments or aspects, the graph profile is updated at predetermined time intervals. In non-limiting embodiments or aspects, the plurality of time periods comprises at least two of the following: 6 hours, 12 hours, 18 hours, 24 hours, 3 days, 7 days, 1 month, 3 months, 6 months, 1 year, or any combination thereof. In non-limiting embodiments or aspects, the plurality of features comprises at least one individual node feature, at least one local feature, and at least one global feature. In non-limiting embodiments or aspects, the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof. In non-limiting embodiments or aspects, the plurality of features comprise a neighboring node similarity. In non-limiting embodiments or aspects, the plurality of features comprise node centrality.

According to non-limiting embodiments or aspects, provided is a system comprising at least one processor programmed or configured to: generate a graph data structure based on a plurality of transactions between a plurality of accounts, wherein each account of the plurality of accounts is represented by a node in the graph data structure, and wherein each transaction of the plurality of transactions is represented by an edge in the graph data structure; determine a plurality of features of the graph data structure for each account of the plurality of accounts; generate a graph profile for at least one account of the plurality of accounts based on the plurality of features for the at least one account, the graph profile based on account activity over each of a plurality of time periods; and update the graph profile for the at least one account based on at least one new transaction engaged in by the at least one account.

In non-limiting embodiments or aspects, the graph profile is updated at predetermined time intervals. In non-limiting embodiments or aspects, the plurality of time periods comprise at least two of the following: 6 hours, 12 hours, 18 hours, 24 hours, 3 days, 7 days, 1 month, 3 months, 6 months, 1 year, or any combination thereof. In non-limiting embodiments or aspects, the plurality of features comprises at least one individual node feature, at least one local feature, and at least one global feature. In non-limiting embodiments or aspects, the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof. In non-limiting embodiments or aspects, the plurality of features comprise a neighboring node similarity. In non-limiting embodiments or aspects, the plurality of features comprise node centrality.

According to non-limiting embodiments or aspects, provided is a computer program product comprising at least one non-transitory computer-readable medium including program instructions that, when executed by at least one processor, causes the at least one processor to: generate a graph data structure based on a plurality of transactions between a plurality of accounts, wherein each account of the plurality of accounts is represented by a node in the graph data structure, and wherein each transaction of the plurality of transactions is represented by an edge in the graph data structure; determine a plurality of features of the graph data structure for each account of the plurality of accounts; generate a graph profile for at least one account of the plurality of accounts based on the plurality of features for the at least one account, the graph profile based on account activity over each of a plurality of time periods; and update the graph profile for the at least one account based on at least one new transaction engaged in by the at least one account.

In non-limiting embodiments or aspects, the graph profile is updated at predetermined time intervals. In non-limiting embodiments or aspects, the plurality of time periods comprise at least two of the following: 6 hours, 12 hours, 18 hours, 24 hours, 3 days, 7 days, 1 month, 3 months, 6 months, 1 year, or any combination thereof. In non-limiting embodiments or aspects, the plurality of features comprises at least one individual node feature, at least one local feature, and at least one global feature. In non-limiting embodiments or aspects, the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof. In non-limiting embodiments or aspects, the plurality of features comprise a neighboring node similarity. In non-limiting embodiments or aspects, the plurality of features comprise node centrality.

Further non-limiting embodiments or aspects will be set forth in the following numbered clauses:

Clause 1: A computer-implemented method, comprising: generating, with at least one processor, a graph data structure based on a plurality of transactions between a plurality of accounts, wherein each account of the plurality of accounts is represented by a node in the graph data structure, and wherein each transaction of the plurality of transactions is represented by an edge in the graph data structure; determining, with the at least one processor, a plurality of features of the graph data structure; generating, with the at least one processor, a graph profile for at least one account of the plurality of accounts based on the plurality of features for the at least one account, the graph profile based on account activity over each of a plurality of time periods; and updating, with the at least one processor, the graph profile for the at least one account based on at least one new transaction engaged in by the at least one account.

Clause 2: The method of clause 1, wherein the graph profile is updated at predetermined time intervals.

Clause 3: The method of clauses 1 or 2, wherein the plurality of time periods comprises at least two of the following: 6 hours, 12 hours, 18 hours, 24 hours, 3 days, 7 days, 1 month, 3 months, 6 months, 1 year, or any combination thereof.

Clause 4: The method of any of clauses 1-3, wherein the plurality of features comprises at least one individual node feature, at least one local feature, and at least one global feature.

Clause 5: The method of any of clauses 1-4, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

Clause 6: The method of any of clauses 1-5, wherein the plurality of features comprise a neighboring node similarity.

Clause 7: The method of any of clauses 1-6, wherein the plurality of features comprise node centrality.

Clause 8: A system comprising at least one processor programmed or configured to: generate a graph data structure based on a plurality of transactions between a plurality of accounts, wherein each account of the plurality of accounts is represented by a node in the graph data structure, and wherein each transaction of the plurality of transactions is represented by an edge in the graph data structure; determine a plurality of features of the graph data structure for each account of the plurality of accounts; generate a graph profile for at least one account of the plurality of accounts based on the plurality of features for the at least one account, the graph profile based on account activity over each of a plurality of time periods; and update the graph profile for the at least one account based on at least one new transaction engaged in by the at least one account.

Clause 9: The system of clause 8, wherein the graph profile is updated at predetermined time intervals.

Clause 10: The system of clauses 8 or 9, wherein the plurality of time periods comprise at least two of the following: 6 hours, 12 hours, 18 hours, 24 hours, 3 days, 7 days, 1 month, 3 months, 6 months, 1 year, or any combination thereof.

Clause 11: The system of any of clauses 8-10, wherein the plurality of features comprises at least one individual node feature, at least one local feature, and at least one global feature.

Clause 12: The system of any of clauses 8-11, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

Clause 13: The system of any of clauses 8-12, wherein the plurality of features comprise a neighboring node similarity.

Clause 14: The system of any of clauses 8-13, wherein the plurality of features comprise node centrality.

Clause 15: A computer program product comprising at least one non-transitory computer-readable medium including program instructions that, when executed by at least one processor, causes the at least one processor to: generate a graph data structure based on a plurality of transactions between a plurality of accounts, wherein each account of the plurality of accounts is represented by a node in the graph data structure, and wherein each transaction of the plurality of transactions is represented by an edge in the graph data structure; determine a plurality of features of the graph data structure for each account of the plurality of accounts; generate a graph profile for at least one account of the plurality of accounts based on the plurality of features for the at least one account, the graph profile based on account activity over each of a plurality of time periods; and update the graph profile for the at least one account based on at least one new transaction engaged in by the at least one account.

Clause 16: The computer program product of clause 15, wherein the graph profile is updated at predetermined time intervals.

Clause 17: The computer program product of clauses 15 or 16, wherein the plurality of time periods comprise at least two of the following: 6 hours, 12 hours, 18 hours, 24 hours, 3 days, 7 days, 1 month, 3 months, 6 months, 1 year, or any combination thereof.

Clause 18: The computer program product of any of clauses 15-17, wherein the plurality of features comprises at least one individual node feature, at least one local feature, and at least one global feature.

Clause 19: The computer program product of any of clauses 15-18, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

Clause 20: The computer program product of any of clauses 15-19, wherein the plurality of features comprise a neighboring node similarity.

Clause 21: The computer program product of any of clauses 15-20, wherein the plurality of features comprise node centrality.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 illustrates a schematic diagram of a system for graph-based fraud detection according to some non-limiting embodiments or aspects;

FIG. 2 illustrates a graph data structure according to some non-limiting embodiments or aspects;

FIG. 3 illustrates a graph data structure and degree feature according to some non-limiting embodiments or aspects;

FIG. 4 illustrates a graph data structure and node neighborhood feature according to some non-limiting embodiments or aspects;

FIG. 5 illustrates a system for graph-based fraud detection according to some non-limiting embodiments or aspects;

FIG. 6 is a flow diagram for a method for graph-based fraud detection according to non-limiting embodiments or aspects; and

FIG. 7 illustrates example components of a device used in connection with non-limiting embodiments or aspects.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more primary account numbers (PAN), tokens, or other identifiers associated with a customer account. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server computer, or other form of non-mobile computer.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects described herein relate to a system, method, and computer program product for graph-based fraud detection that improves upon existing fraud detection systems. Non-limiting embodiments use graph data structures to allow for determinations to be made based on semantic relationships among entities in a payment network, thus improving the accuracy of fraud detection. The use of a graph-based data structure to analyze transactions allows for optimized graph analysis algorithms to be used, thus using less computing resources than existing fraud systems. Graph profiles allow for unique determinations to be made regarding user behavior at individual, localized, and network-level dimensions. By utilizing these different dimensions of user behavior, the accuracy of artificial intelligence (AI) fraud detection models (e.g., machine-learning models) may be improved.

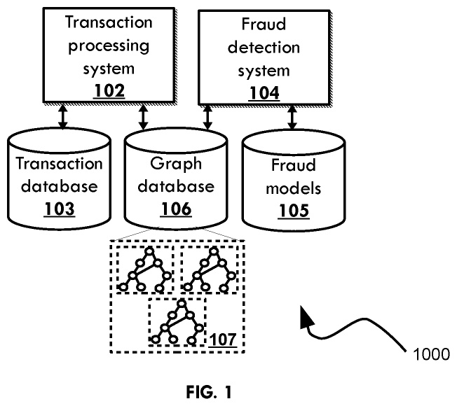

FIG. 1 depicts a system 1000 for graph-based fraud detection according to non-limiting embodiments or aspects. The system 1000 includes a transaction processing system 102 associated with a transaction service provider, which may be arranged in an electronic payment processing network to process payment transactions between various different accounts, each represented by a unique account identifier. For example, the transaction processing system 102 may process and settle transactions between individual account holders, merchants, banks (e.g., issuer institutions and acquirer institutions), and/or other entities. The transaction processing system 102 is in communication with a transaction database 103 that stores transaction data for each transaction processed by the transaction processing system 102. The transaction database 103 may be stored on one or more data storage devices local or remote to the transaction processing system. In some examples, the transaction processing system 102 may be in communication with a payment gateway system to receive incoming transaction requests.

In non-limiting embodiments or aspects, and with continued reference to FIG. 1, the transaction processing system 102 and/or another system in communication with the transaction database 103 (e.g., fraud detection system 104) may generate a graph data structure based on the transactions in the transaction database. The graph data structure may be generated based on transactions from a specified time range or multiple specified time ranges. The graph data structure may represent each account (e.g., separate account identifiers) as a node in the graph, and the transactions between accounts (e.g., nodes) may be represented by an edge in the graph connecting two nodes. The graph data structure may be stored in a graph database 106 along with other graph data structures 107, which may be stored on one or more data storage devices local or remote to the transaction processing system 102.

Still referring to FIG. 1, in non-limiting embodiments or aspects, the system 1000 includes a fraud detection system 104, which may be one or more computing devices executing one or more software applications configured to process transactions and/or account profiles to detect fraudulent behavior. In some examples, the fraud detection system 104 may be part of the transaction processing system 102. In other examples, the fraud detection system 104 may be external to the transaction processing system 102 and provide services to the transaction processing system 102 by communicating through a network. The fraud detection system 104 is in communication with the graph database 106 and with fraud models 105. Fraud models 105 may include one or more models for detecting fraudulent behavior and may be stored on one or more data storage devices local or remote to the fraud detection system 104. In non-limiting embodiments, detecting fraudulent behavior may include identifying a probability of fraudulent behavior by comparing a fraud score (e.g., a risk score) to a threshold and determining if the score satisfies (e.g., meets and/or exceeds) the threshold.

In non-limiting embodiments or aspects, the transaction processing system 102 and/or fraud detection system 104 processes the graph data structure to determine a plurality of features of the graph for each account (e.g., node). The features may be representative of the individual node itself. The features may also be representative of local or global dimensions of each node. For example, features may represent a local node neighborhood (e.g., accounts being interacted with), including similarity of neighboring nodes (e.g., Jaccard similarity, Sorenson similarity, and/or the like). Features may also represent the node in the context of the whole graph data structure, such as similarity to nodes that are not directly connected, a number of triangles formed with neighboring nodes, node centrality, node rank (e.g., using page rank algorithms), and/or the like.

In non-limiting embodiments or aspects, the transaction processing system 102 and/or fraud detection system 104 generates a graph profile for one or more accounts represented by nodes in the graph database 106 based on the features. For example, a graph profile for an account may include values for each feature of a number of features. In some examples, the graph profile for an account may include values generated for each of multiple time intervals such that a value is determined for each feature for each of a number of different time intervals. The values may be combined into an array, vector, and/or other like data format, and used by the fraud detection system 104 as an input to one or more fraud models 105. As new transactions are received and processed by the transaction processing system 102, the graph database 106 and/or graph profiles may be updated. The results of the fraud detection process may be used to train the fraud models 105 and/or to generate new or updated fraud models.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 1000 may perform one or more functions described as being performed by another set of systems or another set of devices of system 1000.

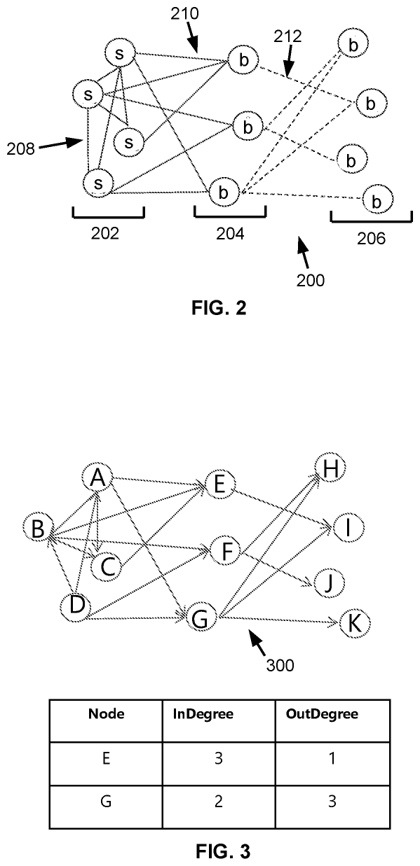

Referring now to FIG. 2, shown is a graph data structure 200 according to non-limiting embodiments or aspects. The graph data structure 200 includes a first set of nodes 202, a second set of nodes 204, and a third set of nodes 206. The first set of nodes 202 may represent sender accounts (e.g., an account identifier from which a payment was sent to another account identifier), the second set of nodes 204 may represent beneficiary accounts (e.g., an account identifier which received a payment from a sender account), and the third set of nodes 206 may represent an additional layer of beneficiary accounts (e.g., an account identifier which received a payment from another beneficiary account directly or from a sender account indirectly). Edges 208, 210, 212 (e.g., vertices connecting nodes of the graph) represent relationships between nodes (e.g., accounts), such as transactions. For example, edge 208 may represent a relationship between two sender accounts, such as a primary account and subaccounts. Edge 210 may represent a payment transaction from a sender account to a receiver account. Edge 212 may represent a relationship between two beneficiary accounts. It will be appreciated that other arrangements and types of relationships may be represented by the edges 208, 210, 212 of the graph data structure 200.

Each node in a graph data structure may be associated with one or more features. Referring to FIG. 3, a graph data structure 300 is shown according to a non-limiting embodiment or aspect to illustrate a degree feature. For example, nodes A-K are connected such that each node represents a different account and each arrow connecting the nodes represent a transaction between accounts. For each node, a degree may be determined based on the number of incoming transactions and the number of outgoing transactions. For example, node E has an incoming degree of 3 because it is a receiver node for 3 transactions from nodes A, B, and C, and an outgoing degree of 1 because it is a sender node for 1 transaction to node I. Thus, the degree of node E may be represented as [3, 1], for example. As another example, node G has an incoming degree of 2 based on being a receiver node for transactions from nodes A and D, and an outgoing degree of 3 based on being a sender node for transactions to nodes H, I, and K.

The degree feature of a node may be time-dependent such that different degree features can be determined for different time periods. For example, a node may have a number of incoming and/or outgoing transactions in the past 6 hours, a number of transactions in the past 12 hours, a number of transactions in the past 18 hours, a number of transactions in the past 24 hours, a number of transactions in the past 3 days, a number of transactions in the past 7 days, a number of transactions in the past month, and/or the like.

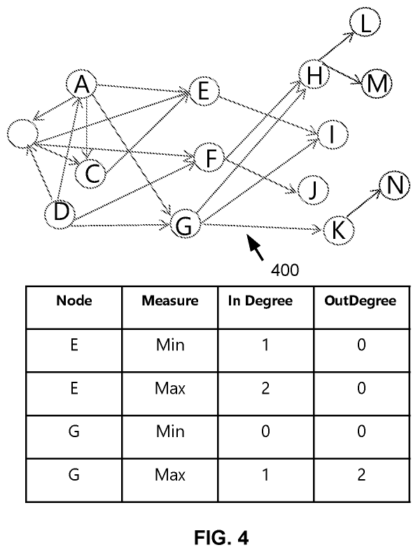

Referring to FIG. 4, a graph data structure 400 is shown according to a non-limiting embodiment or aspect to illustrate a node neighborhood feature. For each node A-N, a degree may be determined based on the number of incoming transactions and the number of outgoing transactions of neighboring nodes. There may be a minimum and a maximum of both incoming and outgoing transactions. As an example, node E has a minimum incoming degree of 1, a minimum outgoing degree of 0, a maximum incoming degree of 2, and a maximum outgoing degree of 0. This is determined based on incoming transactions from an originating node, node A, and node C, and an outgoing transaction to node I, all of which are neighboring nodes (e.g., connected to node E by a single hop). Of these neighboring nodes, node I has the fewest incoming transactions (a single transaction from node E) and therefore the minimum incoming degree is 1. Node I also has the fewest outgoing transactions (none), and therefore the minimum outgoing degree of node E neighboring nodes is 0. Similarly, node G has a minimum incoming degree of 0, a minimum outgoing degree of 0, a maximum incoming degree of 1, and a maximum outgoing degree of 2. The standard deviation and/or average of degrees of neighboring nodes may be determined in some non-limiting embodiments as a feature value for a node.

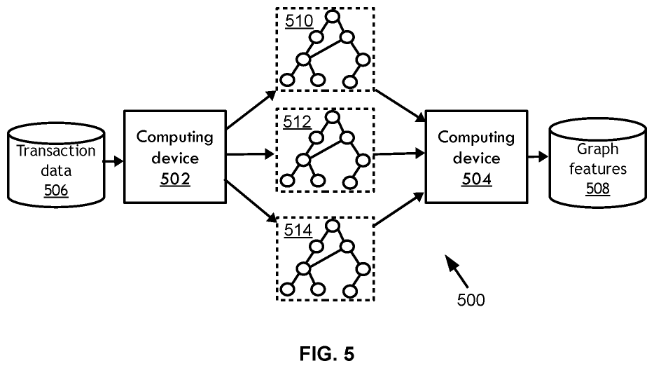

FIG. 5 depicts a system 5000 for graph-based fraud detection according to non-limiting embodiments or aspects. The system 5000 includes transaction data 506 stored on a data storage device in communication with a computing device 502 that is programmed or configured to extract transaction data 506 and generate a graph data structure representing accounts as nodes and transactions as edges between nodes.

The computing device 502 may be programmed or configured with one or more algorithms to generate and output a plurality of temporal graph data structures 510, 512, 514 for different accounts based on the graph data structure. For example, temporal graph data structures 510, 512, 514 may be generated based on a first account. The temporal graph data structure 510 may represent transactions in a first time period (e.g., transactions in the past 6 hours), the temporal graph data structure 512 may represent transactions in a second time period (e.g., transactions in the past 12 hours), and the temporal graph data structure 514 may represent transactions in a third time period (e.g., transactions in the past 24 hours). Various time periods may be used, and any number of temporal graph data structures may be generated.

With continued reference to FIG. 5, computing device 504 may be programmed or configured to generate a plurality of graph features from each of the temporal graph data structures 510, 512, 514. Computing device 504 may be the same or different computing device as computing device 502. The features may include, for example, degrees for each node (e.g., a number of incoming and outgoing transactions), maximum and minimum degrees for neighboring nodes of each node, node centrality, node rank, number of triangles formed with neighboring nodes, similarity of neighboring nodes (e.g., Jaccard similarity, Sorenson similarity, and/or the like), similarity to nodes that are not directly connected, k-core (e.g., values after removing vertices with a higher than k degree), Katz centrality, and/or other graph-based features. The features may be configured to represent how accounts interact and/or are likely to interact. The features may be stored as graph features data 508 in a data storage device. The combined features for an account may be used as or as part of an account profile. In non-limiting embodiments, a fraud detection system (not shown in FIG. 5) is in communication with the graph features data 508 and/or account profiles such that the graph features for a particular account may be used to generate a fraud score.

In non-limiting embodiments, a centrality feature may measure an influence of a vertex in a graph data structure and may be represented as a ratio between the shortest paths passing through a vertex and a total number of shortest paths between all pairs of vertices. Pagerank similarity may measure an importance of a node in a graph data structure, and highly-scored nodes may indicate that the node may be part of a collusive group. Link predication is a similarity feature that may use a Jaccard coefficient and represent local overlap between nodes, which may be used to predict how likely accounts are to interact with an artificial intelligence (AI) model. Local neighborhood overlap is a similarity feature that may use a Sorenson index and represent a local overlap (e.g., similarity) between nodes. This feature may quantify node overlap while minimizing bias due to node degree and may add more weight to nodes that may be part of a neighborhood and give less weight to outliers, as compared to Jaccard similarity. A number of triangles feature may represent local clustering and, in some examples, may be determined as a ratio between a number of triangles an account is part of (e.g., a number of three-node clusters directly connected with vertices (single hop) that include the account node and a total possible number of triangles in the account's neighborhood (e.g., including neighboring nodes)). The number of triangles feature may be used to detect dense (e.g., tightly clustered) neighborhoods of accounts on the graph that may be working together (e.g., collusion). The Katz index feature (e.g., global neighborhood overlap) may represent a number of paths between a pair of nodes. This may find relationships between nodes (e.g., accounts) that have no common neighboring nodes but are still part of the same community within the graph. The f-core feature may include a representation of a maximal subgraph that contains nodes of degree K or more from a particular node. Each node (e.g., account) may be assigned a core number, and this may be used to identify similar nodes (e.g., accounts having similar characteristics) at a network level. A degree histogram feature may represent a degree distribution of the graph (e.g., distribution of degrees by incoming and outgoing transactions). The degree histogram feature is a node-level feature that may involve generating a histogram for the number of degrees for each node, which identifies “hub” accounts having a high degree of incoming and/or outgoing transactions.

The generated graph features may capture the individual, local, and global behavior of an account in a payment ecosystem. The features may be generated for each temporal graph data structure, thereby capturing account activity at different look-back intervals (e.g., last 6 hours, last 12 hours, last 24 hours, last 3 days, last week, last month, and/or the like). An account profile may include features generated for each of these look-back intervals. In non-limiting embodiments, the account profiles may be updated at regular intervals (e.g., every day or the like) to capture the account activity at a payment network level. In some examples, new accounts detected in the graph data structures will result in the creation of a new account profile. Accordingly, at an point in time, the graph features data 508 may be queried to obtain a latest account profile for each account participating in a payment network. In some non-limiting embodiments, the account profiles may be used with an AI platform. For example, the account profiles may be used to train one or more AI models used to detect fraudulent activity in real-time (e.g., for transactions as they are being processed, such as before a transaction is authorized, completed, and/or the like).

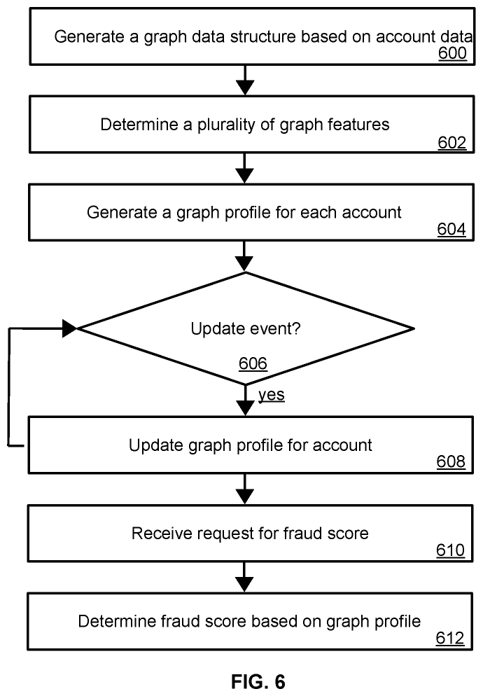

Referring now to FIG. 6, shown is a flow diagram for a method for graph-based fraud detection according to non-limiting embodiments or aspects. The method may include fewer, additional, different, and/or a different order of steps than shown in the example of FIG. 6. In some non-limiting embodiments or aspects, a step may be performed automatically in response to the completion of a previous step. At step 600, a graph data structure is generated based on account data.

At step 602, a plurality of graph features are determined from the graph data structure. A plurality of features may be determined for each account (e.g., node). The features may be representative of the individual node itself and/or local or global dimensions of each node. For example, features may represent a local node neighborhood (e.g., accounts being interacted with), including similarity of neighboring nodes (e.g., Jaccard similarity, Sorenson similarity, and/or the like). Features may also represent the node in the context of the whole graph data structure, such as similarity to nodes that are not directly connected, a number of triangles formed with neighboring nodes, node centrality, node rank (e.g., using page rank algorithms), and/or the like.

At step 604, a graph profile is generated for each account based on the features determined at step 602. A graph profile for an account may include values for each feature of a number of features. In some examples, the graph profile for an account may include values generated for each of multiple time intervals, such that a value is determined for each feature for each of a number of different time intervals. The values may be combined into an array, vector, and/or other like data format. At step 606, it is determined whether an update event has occurred. An update event may include, for example, passage of a predetermined time period (e.g., one day). An update event may also include a new transaction being processed for an account, a request received by a user or system, and/or the like.

In response to the update event occurring (e.g., a day passing), the method may proceed to step 608 and the graph profile for the account and/or other accounts in the payment network may be updated. Updating a graph profile may include adding and/or modifying features for the corresponding account based on new account data (e.g., new transaction data) for the account since the previous update. In non-limiting embodiments, one or more graph profiles may be retained (e.g., unmodified), one or more new graph profiles may be added (e.g., for new accounts and/or account holders), and/or one or more graph profiles may be replaced.

At step 610, a request for a fraud score may be received. As an example, this may include a fraud system receiving a query that identifies the account. In some examples, a request may be made in response to a transaction being requested such that a system involved in the transaction processing (e.g., issuer system, transaction processing system, and/or the like) can use the risk score to determine whether to authorize or decline a transaction. At step 612, in response to the request, a fraud score may be determined by a fraud scoring system. As an example, graph profiles, including numerical values for different graph features, may be combined with an algorithm to determine a score. In some examples, the graph profiles and/or numerical values of features of the graph profiles may be input into a fraud model.

In non-limiting embodiments, the graph features may be scalable and extensible. For example, graph features may be extendable from an account-level (e.g., node level) to other entities in a real-time payment network such that nodes in the graph profiles may represent bank account numbers, routing numbers, and/or other identifiers used in a payment network. Such an extension may help capture the entity behavior at a broader dimension and help increase the overall impact of the graph-based behavior in understanding the underlying behavior/patterns in a network

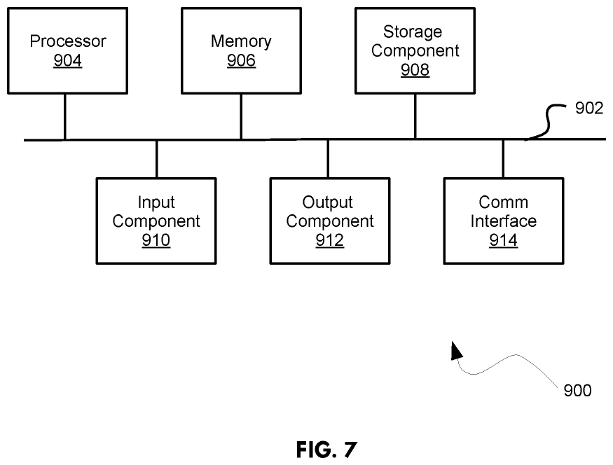

Referring now to FIG. 7, shown is a diagram of example components of a device 900 according to non-limiting embodiments or aspects. Device 900 may correspond to the transaction processing system 102 and/or fraud detection system 104 shown in FIG. 1, as an example. In some non-limiting embodiments or aspects, such systems or devices may include at least one device 900 and/or at least one component of device 900. The number and arrangement of components shown are provided as an example. In some non-limiting embodiments or aspects, device 900 may include additional components, fewer components, different components, or differently arranged components than those shown in FIG. 7. Additionally, or alternatively, a set of components (e.g., one or more components) of device 900 may perform one or more functions described as being performed by another set of components of device 900.

As shown in FIG. 7, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 7, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
generating, with at least one processor, a graph data structure based on a plurality of transactions between a plurality of accounts, wherein each account of the plurality of accounts is represented by a node in the graph data structure, and wherein each transaction of the plurality of transactions is represented by an edge in the graph data structure;
determining, with the at least one processor, a plurality of features of the graph data structure;
generating, with the at least one processor, a graph profile for at least one account of the plurality of accounts based on the plurality of features for the at least one account, the graph profile based on account activity over each of a plurality of time periods; and
updating, with the at least one processor, the graph profile for the at least one account based on at least one new transaction engaged in by the at least one account.

2. The method of claim 1, wherein the graph profile is updated at predetermined time intervals.

3. The method of claim 1, wherein the plurality of time periods comprises at least two of the following: 6 hours, 12 hours, 18 hours, 24 hours, 3 days, 7 days, 1 month, 3 months, 6 months, 1 year, or any combination thereof.

4. The method of claim 1, wherein the plurality of features comprises at least one individual node feature, at least one local feature, and at least one global feature.

5. The method of claim 1, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

6. The method of claim 1, wherein the plurality of features comprise a neighboring node similarity.

7. The method of claim 1, wherein the plurality of features comprise node centrality.

8. A system comprising at least one processor programmed or configured to:
generate a graph data structure based on a plurality of transactions between a plurality of accounts, wherein each account of the plurality of accounts is represented by a node in the graph data structure, and wherein each transaction of the plurality of transactions is represented by an edge in the graph data structure;
determine a plurality of features of the graph data structure for each account of the plurality of accounts;
generate a graph profile for at least one account of the plurality of accounts based on the plurality of features for the at least one account, the graph profile based on account activity over each of a plurality of time periods; and
update the graph profile for the at least one account based on at least one new transaction engaged in by the at least one account.

9. The system of claim 8, wherein the graph profile is updated at predetermined time intervals.

10. The system of claim 8, wherein the plurality of time periods comprise at least two of the following: 6 hours, 12 hours, 18 hours, 24 hours, 3 days, 7 days, 1 month, 3 months, 6 months, 1 year, or any combination thereof.

11. The system of claim 8, wherein the plurality of features comprises at least one individual node feature, at least one local feature, and at least one global feature.

12. The system of claim 8, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

13. The system of claim 8, wherein the plurality of features comprise a neighboring node similarity.

14. The system of claim 8, wherein the plurality of features comprise node centrality.

15. A computer program product comprising at least one non-transitory computer-readable medium including program instructions that, when executed by at least one processor, causes the at least one processor to:
generate a graph data structure based on a plurality of transactions between a plurality of accounts, wherein each account of the plurality of accounts is represented by a node in the graph data structure, and wherein each transaction of the plurality of transactions is represented by an edge in the graph data structure;
determine a plurality of features of the graph data structure for each account of the plurality of accounts;
generate a graph profile for at least one account of the plurality of accounts based on the plurality of features for the at least one account, the graph profile based on account activity over each of a plurality of time periods; and
update the graph profile for the at least one account based on at least one new transaction engaged in by the at least one account.

16. The computer program product of claim 15, wherein the graph profile is updated at predetermined time intervals.

17. The computer program product of claim 15, wherein the plurality of time periods comprise at least two of the following: 6 hours, 12 hours, 18 hours, 24 hours, 3 days, 7 days, 1 month, 3 months, 6 months, 1 year, or any combination thereof.

18. The computer program product of claim 15, wherein the plurality of features comprises at least one individual node feature, at least one local feature, and at least one global feature.

19. The computer program product of claim 15, wherein the plurality of features comprise at least one of the following individual node features: a number of account nodes connected with inbound transactions to a node, a number of account nodes connected with outbound transactions to a node, a number of transactions associated with neighbor nodes of a node, a centrality of a node, a rank of a node, or any combination thereof.

20. The computer program product of claim 15, wherein the plurality of features comprise a neighboring node similarity.

21. The computer program product of claim 15, wherein the plurality of features comprise node centrality.
